(19) United States
(12) Patent Application Publication
(10) Pub. No.: US 2008/0104021 A1
(43) Pub. Date: May 1, 2008

(54) SYSTEMS AND METHODS FOR CONTROLLING ACCESS TO ONLINE PERSONAL INFORMATION

(76) Inventors: Yigang CAI, Naperville, IL (US); Shiyan Hua, Lisle, IL (US)

Correspondence Address: DUFT BORNSEN & FISHMAN, LLP, 1526 SPRUCE STREET, SUITE 302, BOULDER, CO, 80302, US

(21) Appl. No.: 11/554,379

(22) Filed: Oct. 30, 2006

(51) Int. Cl. G06F 17/30

(52) U.S. Cl. 707/3

(57) ABSTRACT

Systems and methods are disclosed for controlling access to online personal information in an online search. In one embodiment of the invention, a method is provided for controlling access to personal information in an online search. The method comprises receiving a search term regarding an individual from a device. The method further comprises identifying privacy criteria indicating personal information regarding the individual to be excluded from the online search. The method further comprises performing the online search based on the search term and the privacy criteria to generate filtered search results that exclude the personal information of the individual indicated by the privacy criteria, and providing the filtered search results to the device.

### BACKGROUND

1. Field of the Invention

The invention relates generally to the field of computerized search engines, and particularly to methods and systems for controlling access to online personal information.

2. Statement of the Problem

As internet searching capability is growing in sophistication and scope, controlling access to personal information is becoming a challenge and a high priority for both individuals and organizations. Until recently, most public records were widely scattered in hundreds of libraries, city halls and courthouses around the country. The wide scattering of public records represented a minimal threat to privacy, as it might be very difficult for an individual to acquire all of the public records related to another individual. Today though, such public records are available on the internet, and many public records have been aggregated into individual profiles by the data-brokerage industry. The aggregation of public records, as well as the ease of acquiring computerized versions of these records to the average person is a potential threat to the privacy of individuals, businesses and organizations. There are no effective safeguards in place to allow an individual to protect or prohibit access to an aggregation of his or her private information.

For example, an aggregation of public records of an individual may be used for identity theft. In the past, significant resources may have been expended by an impersonator to acquire the information necessary to impersonate a victim. An impersonator may have acquired some of the information through public records held at various facilities to piece together the required information to perpetuate an identity theft or other crime using the victim's personal identity. Today though, an internet search may reveal a victim's personal address, credit information, work and salary history, marriage information, real estate records and transactions, etc.

In a matter of minutes, an impersonator may now have enough information to apply for credit cards and mortgages under the victim's identity, with potentially serious consequences, such as damaging the victim's credit. Further, information acquired may be used to blackmail a victim. Additionally, many individuals wish to keep their personal information from being disclosed to avoid stalking and/or harassment by other individuals. A victim can expend significant time and resources keeping their personal information from being disclosed to hide their physical location and/or other personal information, only to see it inadvertently disclosed over the internet to another individual that may pose a threat of physical harm or other harm to the victim.

One problem with the breadth of internet searching is that there are no effective safeguards for individuals to control access to personal information and public records stored on the internet and other computer systems. Though these records may still be scattered on hundreds of web sites and computerized depositories, an internet search may provide access to all of these records at once. Access to a small number of these records may not necessarily pose a privacy problem, but the aggregation of these records may pose significant threats to an individual's privacy. Unfortunately, current search engine technology does not allow an individual to effectively control access to the aggregation of these records.

### SUMMARY OF THE SOLUTION

The invention solves the above problems and other problems with systems and methods for controlling access to personal information in an online search. Normally, a search engine system will receive a search term regarding an individual from a user, and provide all of the located search results relating to the search term to a user. The search results may comprise personal information of the individual that is desired to be kept private. According to features and aspects herein, individuals may specify privacy criteria indicating types of personal information that the individual desires to be excluded from an online search performed by a search engine system. In response to a search term received from the user, the search engine system may generate search results excluding personal information indicated by the privacy criteria from the search results provided to the user. Advantageously, an individual may exclude his or her personal information from an online search, allowing the individual to maintain his or her privacy.

One embodiment of the invention is a search engine system for controlling access to personal information in an online search. The search engine system comprises an interface system adapted to receive a search term regarding an individual from a device. The search term may comprise a name or other identifying information of an individual, such as an email address or phone number. The search engine system further comprises a processing system coupled to the interface system adapted to identify privacy criteria indicating personal information regarding the individual to be excluded from the online search. For example, an individual may desire to hide his or her personal address from an internet search, and the personal information may comprise the personal address. The search engine system further comprises a searching system coupled to the processing system adapted to perform an online search based on the search term and the privacy criteria to generate filtered search results that exclude the personal information of the individual indicated by the privacy criteria. The searching system is further adapted to provide the filtered search results to the device. For example, if the personal information comprises a personal address, then the searching system may generate search results that include one or more records that include the personal address of the individual, and may filter the search results to remove records that include the individual's personal address.

Another embodiment of the invention is a method for controlling access to personal information. The method for controlling access to personal information comprises receiving a search term regarding an individual from a device. The method further comprises identifying privacy criteria indicating personal information regarding the individual to be excluded from the online search. The method further comprises performing the online search based on the search term and the privacy criteria to generate filtered search results that exclude the personal information of the individual indicated by the privacy criteria, and providing the filtered search results to the device.

The invention may include other exemplary embodiments described below.

### DESCRIPTION OF THE DRAWINGS

The same reference number represents the same or similar element on all drawings.

FIG. 1 illustrates a search engine system for controlling access to personal information in an online search in an exemplary embodiment of the invention.

FIG. 2 is a flow chart illustrating a method for controlling access to personal information in an online search in an exemplary embodiment of the invention.

FIG. 3 illustrates a method for identifying the privacy criteria by querying a privacy database in an exemplary embodiment of the invention.

FIG. 4 is a flow chart illustrating a method for controlling access to personal information in an exemplary embodiment of the invention, wherein the method determines if the device is operated by a law enforcement entity

FIG. 5 illustrates screenshots of search results generated by the search engine system.

FIG. 6 is a flow chart illustrating a method for controlling access to personal information in an online search in an exemplary embodiment of the invention.

FIG. 7 illustrates a searching system comprising a privacy database in an exemplary embodiment of the invention.

FIG. 8 illustrates one embodiment of records comprising the privacy database.

### DETAILED DESCRIPTION OF THE INVENTION

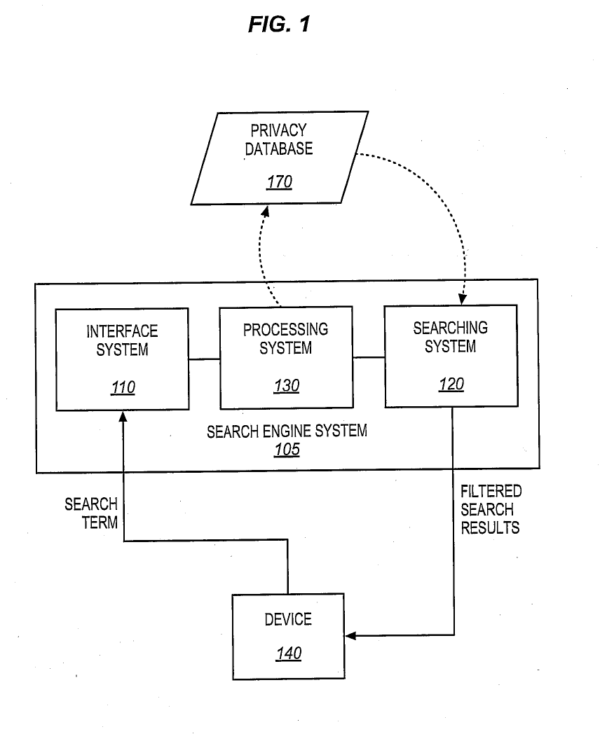

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a search engine system 105 for controlling access to personal information in an online search in an exemplary embodiment of the invention. The search engine system 105 comprises an interface system 110. The interface system 110 is any system adapted to communicate with a device 140. The search engine system 105 further comprises a processing system 130 coupled to the interface system 110. Processing system 130 refers to a single processing device or a group of inter-operational processing devices. The operation of processing system 130 may be controlled by instructions executable by processing system 130. Some examples of instructions are software, program code, and firmware. The search engine system 105 further comprises a searching system 120 coupled to the processing system 130. The searching system 120 is any system adapted to perform an online search to generate search results based on the search term and provide the search results to the device 140.

In traditional internet searching, a device 140 provides a search term to interface system 105. The searching system 120 coupled to the interface system 110 receives the search term, and generates unfiltered search results that are provided to the device 140. In accordance with the present invention, search engine system 105 filters personal information regarding the individual from the search results based on the privacy criteria identified for the individual, and provides filtered search results to the device 140.

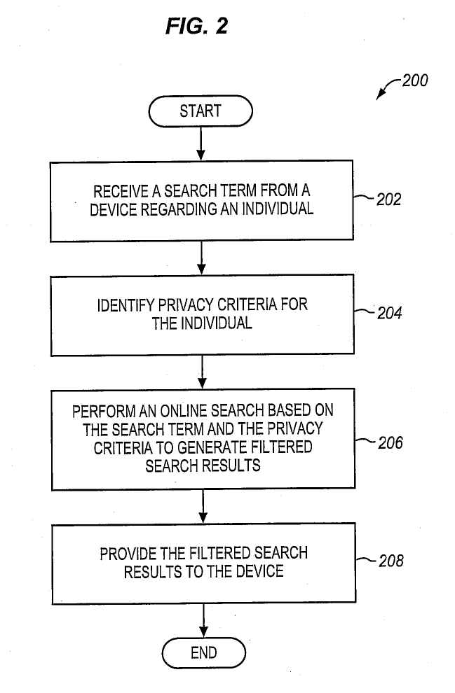

FIG. 2 is a flow chart illustrating a method 200 for controlling access to personal information in an online search in an exemplary embodiment of the invention. The steps of the method 200 will be described with reference to FIG. 1. Method 200 may not be all inclusive, and may include other steps not shown.

In step 202, the interface system 110 receives a search term from the device 140 regarding an individual. The search term may be words, numbers, phrases or a combination of words, numbers and phrases used in an online search to locate records relating to a specified individual. An individual may comprise a person, a group of persons, an organization, a corporation, a government entity, etc. For example, the search term may comprise a name of the individual.

In step 204, the processing system 130 identifies privacy criteria indicating personal information regarding the individual to be excluded from the online search. For example, the personal information for an individual may comprise a personal address, a work address, an instant messaging name, a credit history, a work history, a salary history, a marriage record or history, a personal web site URL, photos or videos, a real estate record or transaction, a voting record, a legal judgment, a property tax record, etc.

The individual may further have an attribute type, indicating the type of individual, such as a corporation, a person, an organization, etc. The attribute type may further specify the types of privacy criteria used to filter the search results. The processing system 130 may be further adapted to determine the attribute type of the individual, and to identify the types of privacy criteria used based on the attribute type of the individual.

In step 206, the searching system 120 performs the online search to generate filtered search results based on the search term and the privacy criteria. The filtered search results exclude the personal information of the individual indicated by the privacy criteria. Those skilled in the art will recognize a variety of ways for generating filtered search results. For example, the filtered search results may be generated and filtered in one step by executing a SQL command on a database, wherein the SQL command searches records matching the search term and excluding the personal information indicated by the privacy criteria. Alternatively, the filtered search results may be generated by searching a database, and each record of the search results located in response to the search term may be parsed to determine if the record comprises personal information. If a record located includes personal information indicated by the privacy criteria, then the record may be removed from the search results. In step 208, the searching system 120 provides the filtered search results to the device 140.

The search engine system 105 may optionally comprise or communicate with a privacy database 170, and the privacy criteria may be identified by querying the privacy database 170. The privacy database 170 is adapted to store an individual identifier indicating information used for identifying the individual. For example, the individual identifier for an individual may comprise a name, an email account name, an internet account name, a phone number, a bank account number, a credit card, a debit card, a calling card number, etc. The individual identifier is associated with the privacy criteria of the individual in the privacy database 170. The processing system 130 is further adapted to determine the privacy criteria of the individual by finding an individual identifier of the individual related to the search term and identifying the privacy criteria associated with the individual identifier. The privacy database 170 may be used to find an individual identifier related to the search term provided by the user and to identify the privacy criteria for the individual. An individual may define privacy criteria and individual identifiers relating to his or her identity and personal information in the privacy database 170. The privacy criteria and individual identifiers instruct the search engine system 105 to exclude personal information related to the individual from an online search.

The privacy database 170 may be operated by a search engine company, and an individual may add his or her name and or other individual identifiers to the privacy database 170 through the search engine web site. Alternatively, the privacy database 170 may be operated by a third party service provider or a government agency. An individual may add his or her name and or other individual identifiers to the privacy database 170, and a search engine system 105 may download the privacy database 170 periodically for use locally on the search engine system 105, or may contact the privacy database 170 on every search to determine if the search term matches a record found in the privacy database 170.

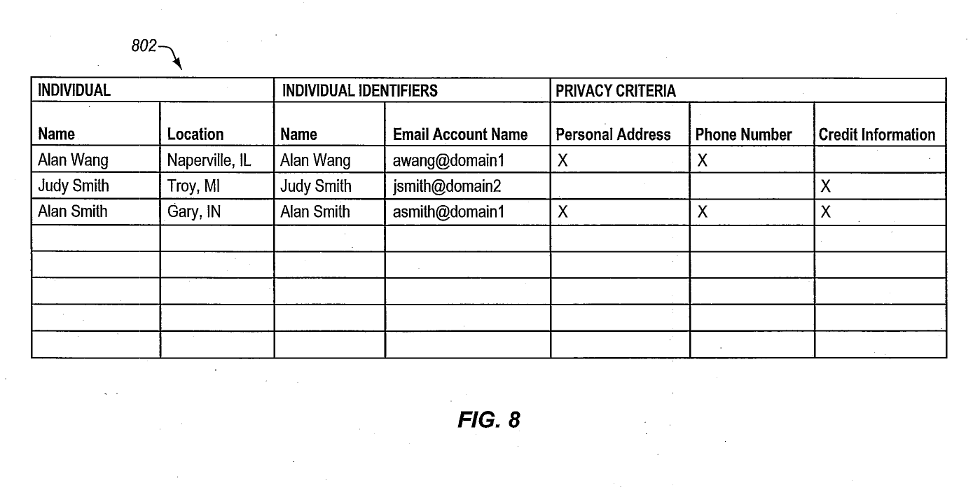

FIG. 8 illustrates one embodiment of records 802 comprising the privacy database 170. For instance, each record 802 of the privacy database 170 may indicate an individual, one or more individual identifiers for the individual, and privacy criteria for the individual. In FIG. 8, the individual is identified by name and physical location so the service provider may locate a record 802 regarding the individual. The individual identifier comprises a name and an email account name as shown in record 802. The privacy criteria comprise a personal address, a phone number and credit information as shown in record 802. The fields in records 802 marked with an “X” value indicate the personal information that the individual desires to be excluded from the online search.

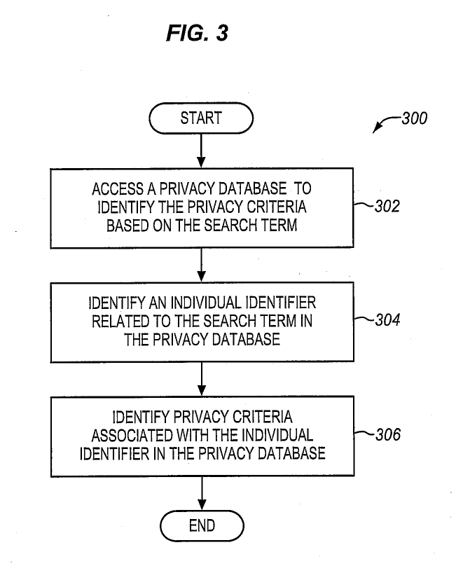

FIG. 3 illustrates a method 300 for identifying the privacy criteria by querying a privacy database 170 in an exemplary embodiment of the invention. The privacy database 170 determines the privacy criteria of the individual by identifying individual identifiers related to the search term, and identifying the privacy criteria associated with the individual identifiers. The steps of the method 300 will be described with reference to FIG. 1. Method 300 may not be all inclusive, and may include other steps not shown.

In step 302, the processing system 130 accesses the privacy database 170 to identify the privacy criteria for the individual based on the search term. The privacy database 170 may be included in the search engine system 105, or may be operated by a third party service provider.

In step 304, the processing system 130 identifies an individual identifier related to the search term in the privacy database 170. For example, if the search term includes “asmith@domain1”, the privacy database 170 may identify the individual “Alan Smith” with the email address “asmith@domain1” found in the privacy database 170. Alternatively, the privacy database 170 may separate the search term into multiple terms, and search for any records related to one of the terms. For example, if the search term includes “Alan Smith”, the privacy database 170 may search for the terms “Alan” or “Smith”, and may identify the records of individuals Alan Wang, Judy Smith or Alan Smith in the privacy database 170.

In step 306, the processing system 130 identifies the privacy criteria associated with the individual identifiers identified in step 304 in the privacy database 170. For example, the search term “Alan Smith” may identify privacy criteria, such as a personal address, a phone number and credit information. The privacy criteria may be used to generate the filtered search results in step 206 of method 200.

A search engine may be required by law to return all records regarding an individual to a law enforcement entity, such as a police officer, even if the individual has designated that the records should be excluded from the online search by the search engine system 105. The processing system 130 may be further adapted to determine if the device 140 is operated by a law enforcement entity, and to return the search results to the device 140 without filtering a record from the search results comprising the personal information for the individual identifier.

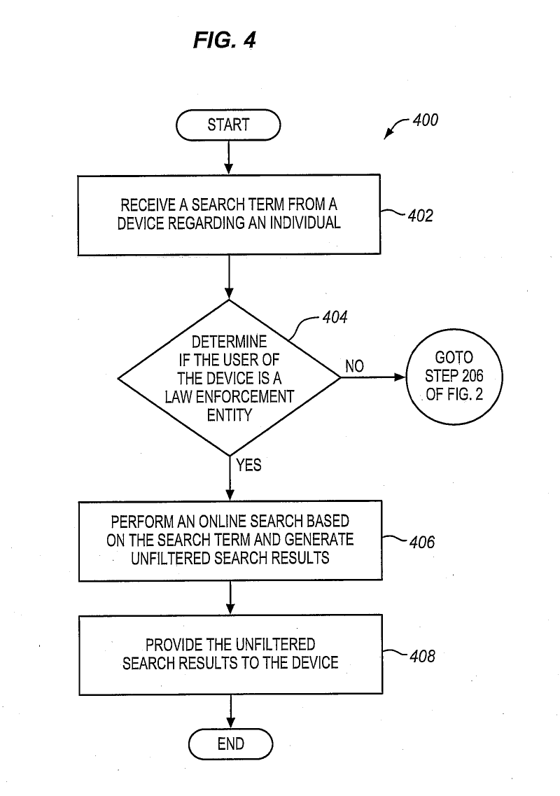

FIG. 4 is a flow chart illustrating a method 400 for controlling access to personal information in an exemplary embodiment of the invention, wherein the method 400 determines if the device 140 is operated by a law enforcement entity. A law enforcement entity may include a police officer or other government agent authorized with law enforcement powers. The steps of the method 400 will be described with reference to FIG. 1. Method 400 may not be all inclusive, and may include other steps not shown.

In step 402, a search term regarding an individual is received by the interface system 110 from the device 140. In step 404, the processing system 130 determines if the device 140 is operated by a law enforcement entity. For example, law enforcement entities may have usernames and passwords for the interface system 110 indicating that the device 140 is operated by a law enforcement entity. If the processing system 130 determines that the device 140 is a law enforcement entity, then the privacy criteria are determined inapplicable for the online search, and the process moves to step 406. Otherwise, if the user of the device 140 is not a law enforcement entity, filtered search results are generated as illustrated in step 206 of method 200.

In step 406, the searching system 120 performs an online search based on the search term and generates unfiltered search results. In step 408, the searching system 120 provides the unfiltered search results to the device 140. While a typical user of device 140 would receive filtered search results with missing records in response to the search term, the law enforcement entity operating the device 140 receives unfiltered search results including records comprising personal information of the individual.

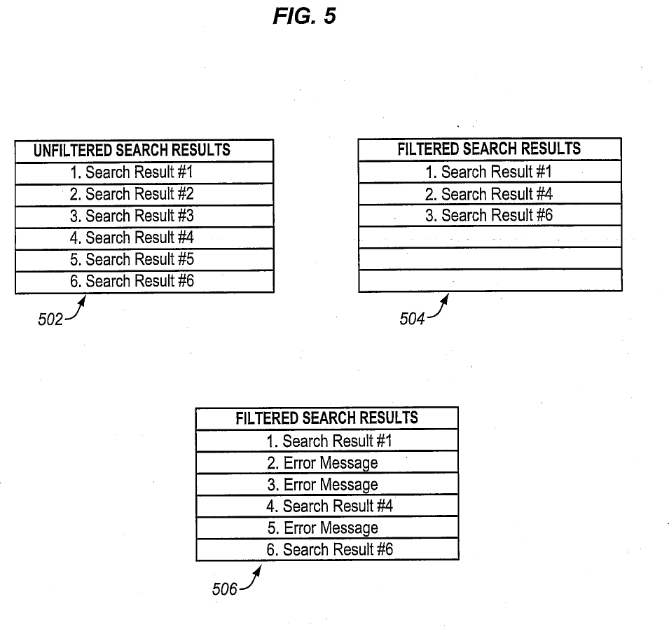

FIG. 5 illustrates screenshots of search results generated by the search engine system 105. Screenshot 502 illustrates unfiltered search results comprising six records. The unfiltered search results in screenshot 502 are typically provided by a searching system 120. The unfiltered search results provide a law enforcement entity with personal information regarding the individual that may otherwise not be available in the filtered search results. By contrast, screenshot 504 illustrates filtered search results comprising three records. According to features and aspects herein, personal information regarding the individual has been excluded from the filtered search results in screenshot 504 based on the privacy criteria identified for the individual.

Based on a combination of a search term and privacy criteria, the search results generated by the searching system 120 may comprise a record not allowed to be provided to the device 140. It may be desirable to provide the device 140 with an explanation for the record removed from the filtered search results. The processing system 130 may be further adapted to return an error message to the device 140 in place of the record removed from the filtered search results. For example, the error message may indicate that the record has been filtered because the search term is prohibited. Screenshot 506 illustrates filtered search results generated by the searching system 120 where three records have been excluded and replaced by error messages, indicating that the record includes prohibited personal information.

Examples are provided to illustrate uses for the systems and methods described herein. In one example, assume that Alice Johnson searches her high school classmate Alan Smith. The interface system 110 receives the search term “Alan Smith” from Alice Johnson. The processing system 130 determines if the individual identifiers “Alan”, “Smith”, or “Alan Smith” are found in the privacy database 170. Alan Wang in Naperville, Ill. registered with the privacy database 170 defining that his personal address and phone number shall not be shared publicly by the search engine system 105. Judy Smith in Troy, Mich. registered with the privacy database 170 defining that her personal credit information shall not be shared publicly by the search engine system 105. Alan Smith in Gary, Ind. registered with the privacy database 170 defining that no data regarding him shall be shared publicly by the search engine system 105. The searching system 120 generates search results comprising 123,456,789 records for the search term “Alan”, “Smith” and “Alan Smith”. The search results comprise 120 records related to addresses and phone numbers of Alan Wang in Naperville, Ill., 240 records related to credit information of Judy Smith in Troy, Mich., and 360 records related to all data of Alan Smith in Gary, Ind. The searching system 120 filters the 720 records from the total 123,456,789 results, and returns the remaining records of the search results to Alice Johnson.

In another example, assume that Officer Bob Johnson of the Naperville Police Department searches for Alan Smith. The interface system 110 receives the search term “Alan Smith” from Bob Johnson. The searching system 120 generates search results comprising 123,456,789 records for the search term “Alan”, “Smith” and “Alan Smith”. The search results comprise 120 records related to addresses and phone numbers of Alan Wang in Naperville, Ill., 240 records related to credit information of Judy Smith in Troy, Mich., and 360 records related to all data of Alan Smith in Gary, Ind. The processing system 120 determines that Bob Johnson is a law enforcement entity, and determines that the privacy criteria are inapplicable. The searching system 120 does not filter any records from the search results, and returns all 123,456,789 records of the search results to Bob Johnson.

The individual identifier and privacy criteria may differ depending on the subject of the search term. For example, if the search term is in regard to a person, the individual identifiers may be a name, an email account name, an internet account name, a phone number, a bank account, a credit card, a debit card, etc. The search engine system 105 may identify whether the search term is in regard to the person by searching the privacy database 170 for individual identifiers matching the search term.

For people, the privacy criteria indicating personal information to excluded from an online search may be set by the person. The personal information may be a home address, a work address, credit information, a work history, a salary history, a marriage history, a web URL, a photo, a real estate transaction, a voting record, a legal judgment, a property tax record, etc. For example, a person may desire to keep private records relating to his or her credit information, salary history and voting records, but may allow the searching system 120 to publish any other records relating to his or her personal information.

The search engine system 105 may also be used to control access to personal information relating to organizations or corporations. The individual identifier for a corporation may include a name of the corporation, an email account name of the corporation, any other internet account name of the corporation, etc. Based upon the search term, the processing system 130 may determine that the search request is in regard to a corporation, and may determine privacy criteria for the organization indicating personal information of the corporation to be kept private by the search engine system 105. For example, the personal information may be a company's proprietary technical documents, accounting data, payroll data, human resource data, legal documents, trade secrets, etc. The searching system 120 may be further adapted to filter the search results based on the privacy criteria identified by the processing system 130 for the individual identifiers of the organization.

The search engine system 105 may also be used to define access to personal information relating to government agencies or government departments. The identity criteria for a government agency may include a name of the government agency, an email account name of the government agency, an internet account name of the government agency, etc. Based upon the search term, the processing system 130 may determine that the search request is in regard to a government agency, and may determine privacy criteria for the individual identifier of the government agency. For example, the personal information may be national security information, government personnel information, classified documents, unclassified documents, government agent identities, facility locations, classified web uniform resource locators, etc. The searching system 120 may be further adapted to filter the search results based on the privacy criteria identified for the individual identifier of the government agency.

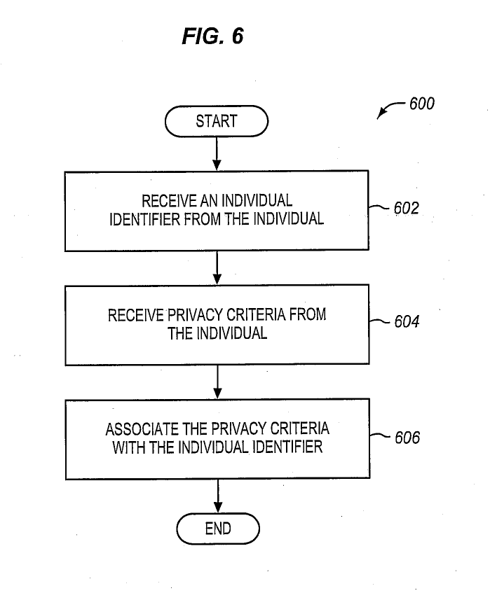

A service provider may further desire to allow an individual to control the privacy criteria regarding his or her personal information. FIG. 6 is a flow chart illustrating a method 600 for controlling access to personal information in an online search in an exemplary embodiment of the invention. The method allows an individual to indicate privacy criteria and individual identifiers to be used by the search engine system 105 for filtering search results. The steps of the method 600 will be described with reference to FIG. 1. Method 600 may not be all inclusive, and may include other steps not shown.

In step 602, the interface system 110 receives at least one individual identifier from the individual, such as a name. In step 604, the interface system 110 receives privacy criteria from the individual defining personal information of the individual to be excluded from the online search.

In step 606, the interface system 110 associates the privacy criteria defined by the individual with the individual identifiers provided by the individual. For example, the individual “Alan Wang” may provide the interface system 110 with his name and his email address “awang@domain1.” Alan Wang may further provide the interface system 110 with personal information related to his personal address and his phone number. The interface system 110 may associate the provided privacy criteria with the provided individual identifiers of “Alan Wang”, and store the information in the privacy database 170 as shown in the record 802 of “Alan Wang” in FIG. 8.

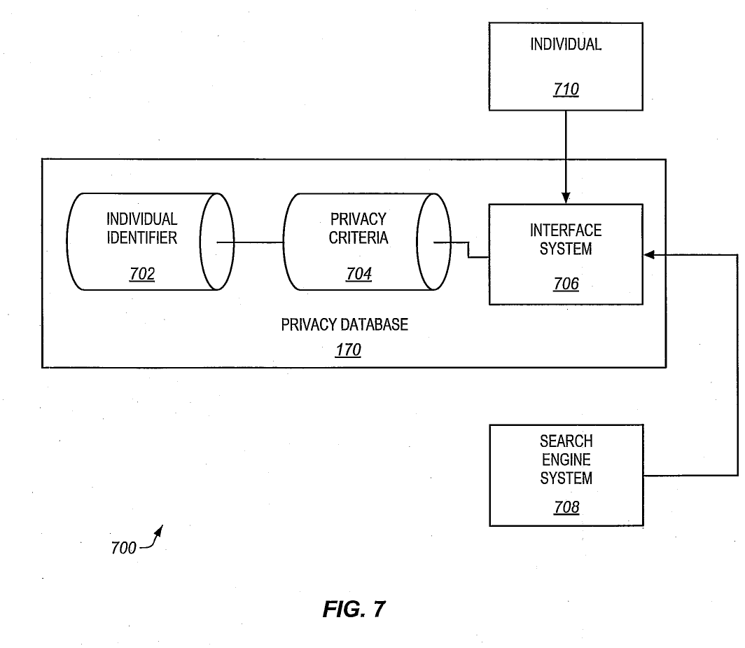

The privacy database 170 provides a means for storing and mapping individual identifiers and privacy criteria. For example, an individual identifier may be a name “Alan Smith” that is associated with privacy criteria, as shown in record 802. To control access to personal information, a depository is used to store and distribute the information needed for the privacy database 170. FIG. 7 illustrates a searching system 700 comprising a privacy database 170 in an exemplary embodiment of the invention. The privacy database 170 comprises a plurality of individual identifiers 702 defined by an individual 710. The privacy database 170 further comprises privacy criteria 704 defined by the individual 710 associated with the individual identifiers 702 indicating a type of personal information of the individual 710 to be excluded from the online search generated by a search engine system 708. The privacy database 170 further comprises an interface system 706 adapted to access the individual identifier 702 and the privacy criteria 704, and adapted to identify an individual identifier 702 based on a search term received from the search engine system 105, and adapted to transmit the privacy criteria 704 associated with the individual identifier 702 to a search engine system 708.

The privacy database 170 may store records regarding individual identifiers 702 and privacy criteria 704 for a plurality of individuals 710. An individual 710 may add his or her name and/or identity to the privacy database 170, and a search engine system 708 may periodically request the records relating to the individual identifier 702 and privacy criteria 704 for all of the individuals 710 referenced in the privacy database 170. Alternatively, a search engine system 708 may contact the privacy database 170 on every search request to determine if the search term matches an individual identifier 702 in a record of the privacy database 170.

The interface system 706 may be further adapted to receive a request from the individual 710 to define the individual identifiers 702 and privacy criteria 704 in a stored record of the individual 710.

Although specific embodiments were described herein, the scope of the invention is not limited to those specific embodiments. The scope of the invention is defined by the following claims and any equivalents thereof.

We claim:

1. A search engine system for controlling access to personal information in an online search, the search engine system comprising:
an interface system adapted to receive a search term regarding an individual from a device;
a processing system coupled to the interface system adapted to identify privacy criteria indicating personal information regarding the individual to be excluded from the online search; and
a searching system coupled to the processing system adapted to perform the online search based on the search term and the privacy criteria to generate filtered search results that exclude the personal information of the individual indicated by the privacy criteria, and adapted to provide the filtered search results to the device.

2. The search engine system of claim 1 further comprising a privacy database comprising a plurality of individual identifiers defined by the individual, wherein the individual identifiers are associated with the privacy criteria of the individual, and the processing system is further adapted to query the privacy database with the search term, and the privacy database is adapted to identify an individual identifier related to the search term and to provide the processing system with privacy criteria associated with the individual identifier related to the search term.

3. The search engine system of claim 1 further comprising a privacy database comprising a plurality of individual identifiers defined by the individual, wherein the individual identifiers are associated with the privacy criteria of the individual, and the processing system is further adapted to query the privacy database for an individual identifier of the individual related to the search term, and adapted to identify the privacy criteria associated with the individual identifier; and adapted to use the privacy criteria identified by the privacy database in response to the query to perform the online search.

4. The search engine system of claim 1 wherein the processing system is further adapted to determine if a user of the device is a law enforcement entity, and to transmit unfiltered search results to the device if the user of the device is a law enforcement entity.

5. The search engine system of claim 1 wherein the searching system is further adapted to provide an error message to the device in place of a record filtered from the search results.

6. The search engine system of claim 1 wherein the interface system is further adapted to allow the individual to define at least one individual identifier identifying the individual, and allow the individual to define privacy criteria for the individual, and the processing system is adapted to associate the privacy criteria of the individual with the at least one individual identifier of the individual.

7. The search engine system of claim 1 wherein the searching system is further adapted to generate the filtered search results by executing a SQL command comprising the search term and the privacy criteria.

8. The search engine system of claim 1 wherein the searching system is further adapted to generate the filtered search results by executing a SQL command comprising the search term, and parsing out at least one record comprising the personal information indicated by the privacy criteria.

9. A method for controlling access to personal information in an online search, the method comprising:
receiving a search term regarding an individual from a device;
identifying privacy criteria indicating personal information regarding the individual to be excluded from the online search;
performing the online search based on the search term and the privacy criteria to generate filtered search results that exclude the personal information of the individual indicated by the privacy criteria; and
providing the filtered search results to the device.

10. The method of claim 9 further comprising
querying a privacy database with the search term, wherein the privacy database comprises a plurality of individual identifiers defined by the individual, wherein the individual identifiers are associated with the privacy criteria of the individual;
identifying an individual identifier in the privacy database related to the search term; and
determining the privacy criteria associated with the individual identifier in the privacy database related to the search term.

11. The method of claim 9 further comprising:
querying the privacy database for an individual identifier of the individual related to the search term;
identifying the privacy criteria associated with the individual identifier; and
using the privacy criteria identified by the privacy database in response to the query to perform the online search.

12. The method of claim 9 further comprising:
determining if a user of the device is a law enforcement entity; and
transmitting unfiltered search results to the device if the user is a law enforcement entity.

13. The method of claim 9 further comprising providing an error message to the user in place of a record filtered from the search results.

14. The method of claim 9 further comprising:
allowing the individual to define at least one individual identifier identifying the individual;
allowing the individual to define at least one privacy criterion for the individual; and
associating the privacy criteria of the individual with the at least one individual identifier of the individual.

15. The method of claim 9 wherein performing the online search comprises executing a SQL command comprising the search term and the privacy criteria to generate the filtered search results.

16. The method of claim 9 wherein performing the online search comprises:
executing a SQL command comprising the search tens; and
parsing a record comprising personal information indicated by the privacy criteria to generate the filtered search results.

17. A privacy database for controlling access to personal information in an online search, the privacy database comprising:
a plurality of individual identifiers defined by an individual indicating identifying information of the individual;
a privacy criteria defined by the individual associated with the individual identifiers indicating a type of personal information of the individual to be excluded from the online search generated by a search engine system; and
an interface system adapted to identify the individual identifier related to a search term received from the search engine system, and to transmit the privacy criteria associated with the individual identifier to the search engine system.

18. The privacy database of claim 17 wherein the interface system is further adapted to receive at least one individual identifier from the individual, and to associate the privacy criteria of the individual with the individual identifier.

19. The privacy database of claim 17 wherein the individual identifiers include at least one of a name, an email account name, an internet account name, a phone number, a bank account, a credit card and a debit card.

20. The privacy database system of claim 17 wherein the privacy criteria includes at least one of a home address, a work address, credit information, a work history, a salary history, a marriage history, a web URL, a photo, a real estate transaction, a voting record, a legal judgment and a property tax record.
